(19) United States
(12) Patent Application Publication
(10) Pub. No.: US 2010/0128074 A1
(43) Pub. Date: May 27, 2010

(54) PRINTING APPARATUS

(75) Inventors: Atsushi MUTO, Shiojiri-shi (JP); Tomohiro SAYAMA, Matsumoto-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/620,651

(22) Filed: Nov. 18, 2009

(30) Foreign Application Priority Data
Nov. 25, 2008 (JP) 2008-299154

(51) Int. Cl. B41J 29/38

(52) U.S. Cl. 347/9

(57) ABSTRACT

A printing apparatus includes: a white-colored ink nozzle which ejects white-colored ink; a colored ink nozzle which ejects colored ink different from the white-colored ink; a scanning mechanism which moves the nozzles and a print medium, onto which the ejected ink is landed, relative to each other; and a controller which controls the ink ejection of the nozzles and the scanning mechanism. The controller forms a color line by ejecting the colored ink onto the print medium, while relatively moving the nozzle with respect to the print medium in a first direction, and then the controller ejects the white-colored ink on the color line so as to draw white lines intersecting the color line by moving the nozzle and the print medium relative to each other in a second direction intersecting the first direction.

### BACKGROUND

1. Technical Field

The present invention relates to a printing apparatus capable of ejecting a liquid onto a print medium from nozzle openings of a liquid ejecting head such as an ink jet print head.

2. Related Art

Examples of a liquid ejecting head, which ejects (jets) liquid droplets from nozzle openings by causing a variation in the pressure of a liquid in pressure chambers, include: an ink jet print head (hereinafter, simply referred to as a print head) used in an image printing apparatus such as an ink jet printing apparatus (hereinafter, simply referred to as a printer); a color material ejecting head used in manufacturing a color filter such as a liquid crystal display; an electrode material ejecting head used in forming an organic EL (Electro Luminescence) display, an FED (Field Emission Display), and the like; and a bio organism ejecting head used in manufacturing a bio chip (biochemical element).

For example, the print head may not appropriately print an image on a print medium (ejecting target), when no ink (liquid) is ejected from any one of plural nozzle openings due to the thickened and solidified liquid caused by spontaneous evaporation of the liquid exposed through the nozzle openings or pressure loss caused due to the bubbles mixed in the liquid in the pressure chambers, that is, when so-called dot missing occurs. For this reason, techniques for inspecting whether the ink is reliably ejected from the nozzle openings have been suggested from the past. For example, JP-A-2004-195862 discloses a printing apparatus capable of embodying a dot missing detection method of easily viewing light-colored ink by ejecting first light-colored ink among light color ink, which is difficult to view on the ejecting target, in a solid manner to form a ground color and forming an ejection inspection pattern with second light-colored ink in the area where the ground color so that the ejected light-colored ink overlaps with each other.

In the above-mentioned technique, however, it is difficult to determine whether the ground color formed by ejecting the light-colored ink on the ejecting target is reliably formed. Moreover, it is difficult to reduce ink consumption of the light-colored ink used to form the ground color, since the range of the area where the second light-colored ink is ejected has to be wider than the ground color formed with the first light-colored ink among the light-colored ink.

### SUMMARY

An advantage of some aspects of the invention is that it provides a printing apparatus capable of detecting an ejection failure of nozzles in a more appropriate manner.

According to an aspect of the invention, there is provided a printing apparatus including: a white-colored ink nozzle which ejects white-colored ink; a colored ink nozzle which ejects colored ink different from the white-colored ink; a scanning mechanism which moves the nozzles and a print medium, onto which the ejected ink is landed, relative to each other; and a controller which controls the ink ejection of the nozzles and the scanning mechanism. The controller forms a color line by ejecting the colored ink onto the print medium, while relatively moving the nozzle with respect to the print medium in a first direction, and then the controller ejects the white-colored ink on the color line so as to draw white lines intersecting the color line by moving the nozzle and the print medium relative to each other in a second direction intersecting the first direction.

The “white-colored ink” refers to ink of a color which is difficult to perceive on the print medium. That is, the white-colored ink is not required to have a completely achromatic color. When the print medium has a “white color”, the white-colored ink includes light-colored ink (for example, light yellow ink).

According to this configuration, the printing apparatus includes: the white-colored ink nozzle which ejects white-colored ink; the colored ink nozzle which ejects colored ink different from the white-colored ink; the scanning mechanism which moves the nozzles and a print medium, onto which the ejected ink is landed, relative to each other; and the controller which controls the ink ejection of the nozzles and the scanning mechanism. The controller forms the color line by ejecting the colored ink onto the print medium, while relatively moving the nozzle with respect to the print medium in the first direction, and then the controller ejects the white-colored ink on the color line so as to draw white lines intersecting the color line by moving the nozzle and the print medium relative to each other in the second direction intersecting the first direction. With such a configuration, the color line of the easily perceivable colored ink can be discontinuous by the white lines of the white-colored ink. Accordingly, it is possible to easily perceive an ejection failure of the white-colored ink nozzle. Moreover, since the ink is ejected so that the color line and the white lines are formed in a line shape, it is possible to reduce ink consumption.

In the printing apparatus having the above-described configuration, a plurality of the white-colored ink nozzles may be provided and the controller may eject the white-colored ink so that the white lines formed by different white-colored ink nozzles among the plurality of white-colored ink nozzles are formed on the color line at a predetermined interval.

With such a configuration, since the plurality of white-colored ink nozzles is provided and the controller ejects the white-colored ink so that the white lines formed by different white-colored ink nozzles among the plurality of white-colored ink nozzles are formed on the color line at the predetermined interval, it is possible to determines whether the flying curve of the white-colored ink occurs by the interval between the white lines.

In the printing apparatus having the above-described configuration, the controller may eject the white-colored ink so that a white line group with a thick width is formed by ejecting the white-colored ink from specific white-colored ink nozzles and drawing the white lines several times.

With such a configuration, since the controller ejects the white-colored ink so as to form the white line group with a thick width by ejecting the white-colored ink from specific white-colored ink nozzles and drawing the white lines several times, the area of the color line covered by the white lines becomes broader. Accordingly, it is possible to easily perceive the ejection failure of the white-colored ink nozzle.

In the printing apparatus having the above-described configuration, the controller may form a plurality of the color lines, and then may eject the white-colored ink so that the white lines formed by being ejected from the different white-colored ink nozzles are arranged in a straight line shape on each of the color lines.

With such a configuration, since the controller forms a plurality of the color lines, and then ejects the white-colored ink so that the white lines formed by being ejected from the different white-colored ink nozzles are arranged in a straight line shape on each of the color lines, it is possible to perceive the ejection failure of the white-colored ink nozzles by a position deviation between the white lines formed on each color line.

The printing apparatus having the above-described configuration may further include a recovery processing unit which performs a recovery process of the white-colored ink nozzles when it is determined that an ejection failure occurs in the white-colored ink nozzle on the basis of the white line.

With such a configuration, since the printing apparatus further includes the recovery processing unit which performs the recovery process of the white-colored ink nozzles when it is determined that an ejection failure occurs in the white-colored ink nozzle on the basis of the white line, it is possible to prevent the ejection failure of the nozzle.

### BRIEF DESCRIPTION OF THE DRAWINGS

The invention will be described with reference to the accompanying drawings, wherein like numbers reference like elements.

FIG. 1 is a perspective view illustrating a printer.

FIG. 2 is a sectional view illustrating the configuration of the main elements of a print head.

FIG. 3 is an exploded perspective view illustrating the configuration of a passage unit.

FIG. 4 is a front view illustrating a nozzle plate.

FIGS. 5A to 5D are explanatory diagrams illustrating tests patterns formed with colored ink and white-colored ink.

### DESCRIPTION OF EXEMPLARY EMBODIMENTS

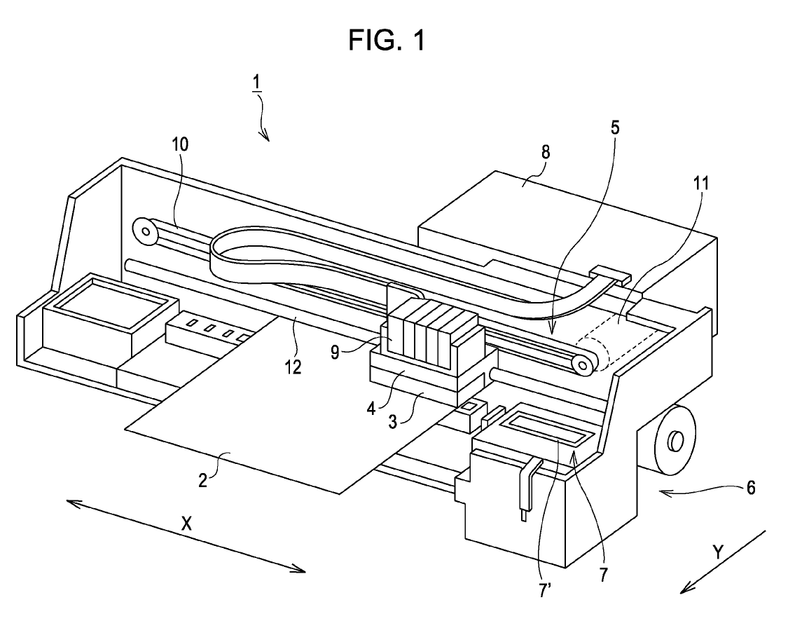

Hereinafter, an exemplary embodiment of the invention will be described with reference to the accompanying drawings. In the following embodiment, the invention is described just as limited to by a variety of appropriate specific examples. However, the invention is not limited to the aspects of the specific examples, as long as the description limiting the invention is particularly not made. In addition, in the following description, an ink jet printing apparatus (hereinafter, abbreviated as a printer) in FIG. 1 corresponds to a printing apparatus according to the invention.

FIG. 1 is a perspective view illustrating a printer 1. The overall configuration of the printer 1 mounted with a print head 3 will be described with reference to FIG. 1. The exemplified printer 1 is an apparatus capable of printing an image or the like by ejecting liquid-like ink onto the surface of a print medium 2 (a kinds of print medium according to the invention) such as a print sheet. In this embodiment, a white normal sheet is used as the print medium 2, for example.

The printer 1 includes: the print head 3 which ejects (jets) ink; a carriage 4 which is mounted with the print head 3; a carriage moving mechanism 5 (a kind of scanning mechanism according to the invention) which moves the carriage 4 in a main scanning direction (indicated by an X in FIG. 1); a sheet transporting mechanism 6 (a kind of scanning mechanism according to the invention) which transports the print medium 2 in a sub-scanning direction (a Y direction perpendicular to the main scanning direction X); a capping mechanism 7 (a kind of recovery processing unit according to the invention) which is disposed at a home position which is a non-print area of the printer 1; and a controller 8 (a kind of controller according to the invention) which controls the entire printer 1. Here, the ink is stored in ink cartridges 9. The ink cartridges 9 each store white (W) ink, yellow (Y) ink, magenta (M) ink, cyan (C) ink, and black (K) ink, for example, respectively. The ink cartridges 9 are detachably mounted on the print head 3.

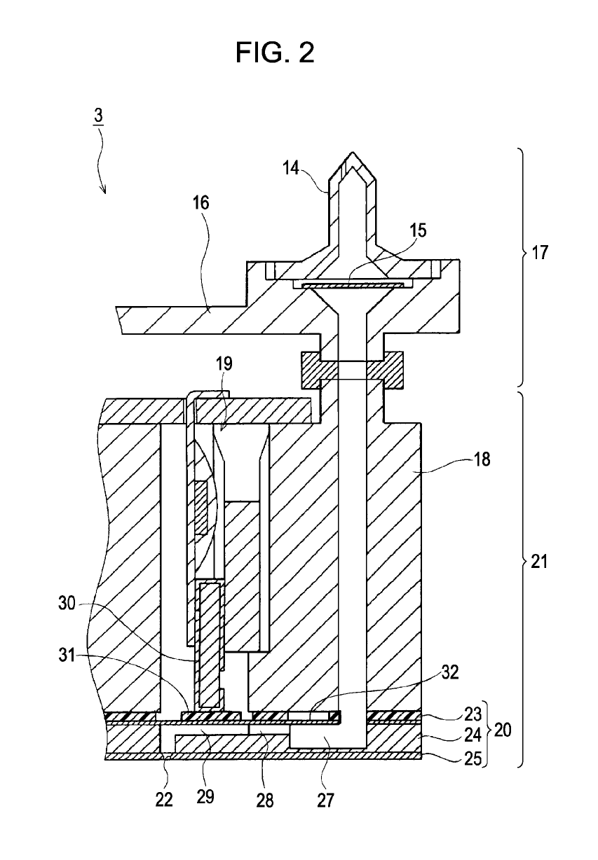

The carriage moving mechanism 5 includes a timing belt 10 connected to the carriage 4. The timing belt 10 is driven by a pulse motor 11 such as a DC motor. Accordingly, when the pulse motor 11 is activated, the carriage 4 is guided by a guide rod 12 disposed in the printer 1 to reciprocate in the main scanning direction X (a width direction of the print medium 2). A cap member 7′ of the capping mechanism 7 seals a nozzle surface of the print head 3. The capping mechanism 7 prevents an ink solvent from evaporating from nozzle openings 22 (which corresponds to nozzles according to the invention, see FIG. 2). The capping mechanism 7 is used to perform a cleaning process of moving bubbles mixed in the ink and a flushing process, which is described, of removing the thickened ink by applying a negative pressure the sealed nozzle surface and forcibly sucking the ink from the nozzle openings 22.

Next, the configuration of the print head 3 will be described.

FIG. 2 is a sectional view illustrating the configuration of the main elements of the print head 3. The print head 3 includes: a filter assembly 17 which includes an ink introduction needle 14, a filter 15, and an introduction needle unit 16; and a head unit 21 which includes a head case 18, a vibrator unit 19 accommodated in the head case 18, and a passage unit 20. Within the print head 3, a series of ink passages (kinds of liquid passage) are formed from the ink cartridge serving as a liquid supply source to the nozzle openings 22 of the passage unit 20.

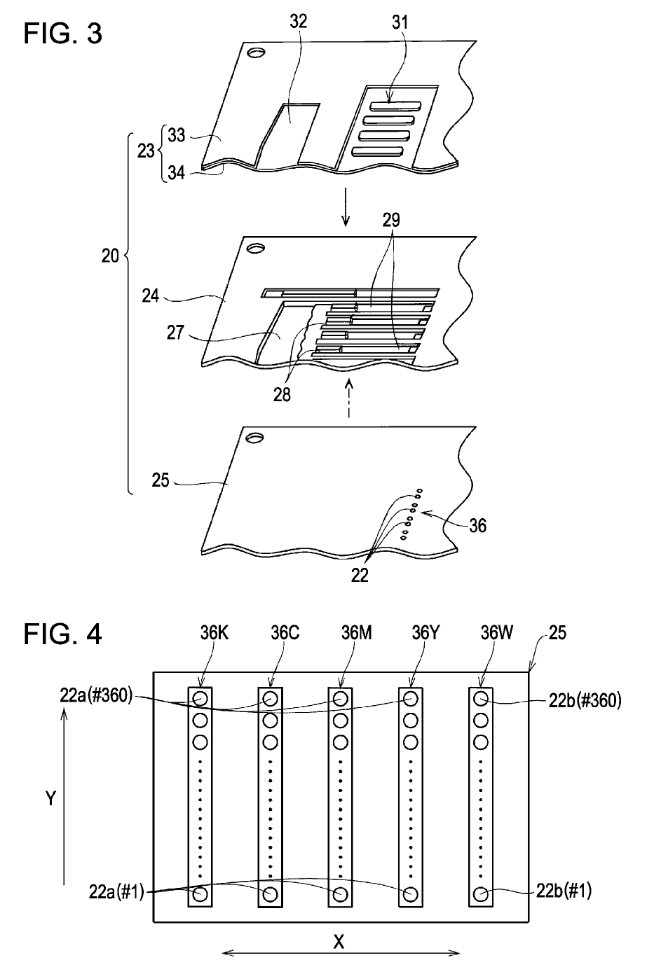

FIG. 3 is an exploded perspective view illustrating the configuration of the passage unit 20 according to this embodiment. The passage unit 20 is joined to the front end surface of the case head 18 in a state where a vibration plate 23, a passage forming board 24, and a nozzle plate 25 are sequentially laminated, as shown in FIG. 3.

The vibration plate 23 is a plate disposed between the passage forming board 24 and the head case 18 and a double-structure complex plate formed by laminating an elastic film 34 on a support plate 33 made of a metal material such as stainless steel. An island section 31 which is joined to the front end surfaces of the free ends of piezoelectric vibrators 30 (pressure generating elements) is formed by removing the portion of the support 33 corresponding to pressure chambers 29 of the vibration plate 23 in a circular shape. The island section 31 functions as a diaphragm. That is, the vibration plate 23 is configured such that the elastic film 34 around the island section 31 is elastically deformed by the operation of the piezoelectric vibrators 30. The vibration plate 23 also functions as a compliance section 32 by sealing the opening of a common ink chamber 27 of the passage forming board 24. A portion of the support plate 33 corresponding to the compliance section 32 is removed by etching the diaphragm so that only the elastic film 34 remains.

The piezoelectric vibrator 30 according to this embodiment is a so-called vertical vibration mode piezoelectric vibrator which is displaced in a direction perpendicular to an electric field direction. When a driving signal is supplied from the controller 8, the piezoelectric vibrator 30 is displaced (expanded or contracted) in a direction perpendicular to a direction in which piezoelectric body and an electrode are laminated. The piezoelectric vibrators 30 are separated from each other at the same pitch as the pitch at which the pressure chambers 29 of the passage unit 20 are formed. The piezoelectric vibrators 30 correspond to the pressure chambers 29 (see FIG. 3) in a one-to-one manner.

The passage forming board 24 is a member which is disposed between the nozzle plate 25 and the vibration plate 23. In the passage forming board 24, hollow sections serving as ink passages such as the common ink chamber 27, which is a kind of common liquid chamber, the ink supply port 28, and the pressure chambers 29 (pressure generating chambers) are partitioned. The passage forming board 24 is manufactured by etching a silicon wafer, for example. The open surfaces of the hollow sections are sealed by the nozzle plate 25 and the vibration plate 23.

The pressure chambers 29 are thin and long chambers arranged in a direction (the sub-scanning direction) perpendicular to an arrangement direction (nozzle row direction) of the nozzle openings 22. The plurality of pressure chambers 29 is arranged in the sub-scanning direction Y in the passage forming board 24. One end of each pressure chamber 29 communicates with the ink supply port 28 and the other end of each pressure chamber 29 communicates with the nozzle openings 22 of the nozzle plate 25. The common ink chamber 27 is a chamber to which the ink is introduced from the ink supply source such as the ink cartridge or a sub-tank. The ink introduced to the common ink chamber 27 is distributed to be supplied to each pressure chamber 29 through the ink supply port 28. That is, as shown in FIG. 2, the passage unit 20 forms the series of ink passages formed by the common ink chamber 27, the ink supply ports 28, the ink chambers 29, and the nozzle openings 22.

FIG. 4 is a front view illustrating the nozzle plate. The nozzle plate 25 disposed on the bottom of the passage unit 20 is a thin metal plate in which the plurality of nozzle openings 22 is formed at a pitch (for example, 360 dpi) corresponding to a dot formation density in the sub-scanning direction Y. The nozzle plate 25 according to this embodiment is made of a plate material such as stainless steel. In the nozzle plate 25, a plurality of rows (nozzle rows 36) of the nozzle openings 22 is arranged in the main scanning direction X of the print head 3. The total five nozzles rows 36 (36W, 36Y, 36M, 36C, and 36K) corresponding to white (W) ink, yellow (Y) ink, magenta (M) ink, cyan (C) ink, and black (K) ink, respectively, are arranged in the main scanning direction X. One nozzle row 36 is constituted by 360 nozzle openings 22, for example.

The print head 3 having the above-described configuration is capable of ejecting the ink, which has been introduced from the ink cartridges 9 to the pressure chambers 29 through the ink passage, as ink droplets from the nozzle openings 22 by making a variation in the pressure of the pressure chambers 29 by the operation of the piezoelectric vibrators 30. The print head 3 is capable of printing an image by landing the liquid droplets onto the print medium 2. However, when the nozzle openings 22 become clogged due to the solidified ink, the ink droplets may not be ejected appropriately. For this reason, the printing apparatus 1 according to this embodiment is configured to print a test pattern used in determining whether an ejection failure of the nozzle openings 22 occurs.

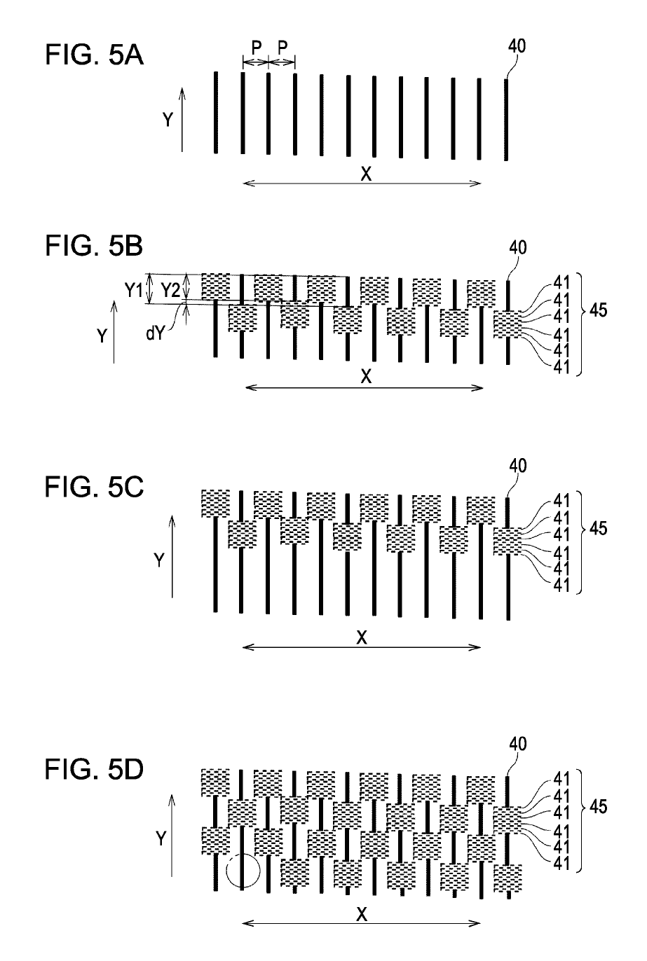

FIGS. 5A and 5D are explanatory diagrams illustrating test pattern formed with colored ink and white-colored ink.

Next, a printing sequence of the test pattern used to determine whether an ejection failure of the nozzle openings 22 occurs. When a test pattern printing mode starts, the printing apparatus 1 according to the invention forms color lines 40 by ejecting colored ink onto the print medium 2 from the nozzle openings 22a and ejects the white-colored ink from the nozzle openings 22b so as to draw white lines 41 intersecting the corresponding color lines 40 on the color lines 40. Here, the nozzle openings 22 ejecting the colored ink (for example, the black (K) ink) are referred to as the nozzle openings 22a and the nozzle openings 22 ejecting white-colored ink (for example, white (W) ink) are referred to as the nozzle openings 22b.

When the test pattern printing mode starts, the printing apparatus 1 first controls the sheet transporting mechanism 7 to transport the print medium 2 in the sub-scanning direction Y and controls the carriage moving mechanism 5 to slide the print head 3 from one end (initial side) to a predetermined print start position of the print medium 2 and stop the print head 3 for the moment. Then, the driving signal from the controller 8 is applied to the piezoelectric vibrators 18 corresponding to the colored ink nozzle openings 22a belonging to the colored ink nozzle row 36K to eject the colored ink droplets from the colored ink nozzles 22a. In this way, a part of the colored ink test pattern with a length corresponding to one nozzle row is formed (printed) on the print medium 2.

Subsequently, the print head 3 is moved by a predetermined distance in the scanning direction X by the carriage moving mechanism 5, and then the colored ink is ejected from the respective colored ink nozzles 22a at this position. By repeating this operation in the entire image formation area of the print medium 2, plural parts (for example, 180 lines) of the colored ink test pattern with the length corresponding to one nozzle row are formed at a predetermined interval P in the main scanning direction X. The print head 3 is returned to the initial side, when the print head 3 is moved from the print start position to the print end position of the image formation area of the print medium 2, and then the printing ends. Subsequently, after the print medium 2 is transported by one nozzle row in the sub-scanning direction Y, a segment of the line of the respective colored ink test pattern extends by one nozzle row by ejecting the colored ink at the predetermined interval P from the respective colored ink nozzles 22a of the print head 3, while the print head 3 is moved in the main scanning direction X again. By repeating this operation, the plurality of colored ink test patterns formed with the colored ink in the sub-scanning direction Y are formed at the predetermined interval P in the main scanning direction X (see FIG. 5A).

Next, after the plurality of colored ink test patterns are formed on the print medium 2 and the print medium 2 is returned, the print medium 2 and the print head 3 are aligned by the sheet transporting mechanism 7 and the carriage moving mechanism 5 so that, for example, a first white-colored ink nozzle 22b (#1) of the white-colored ink nozzles 22b belonging to the white-colored ink nozzle row 36W faces the print start position located in the most front (the initial side) of the color line 40. Subsequently, by continuously ejecting the white-colored ink to draw lines while the print head 3 is moved in the main scanning direction X by the interval P between the color lines 40, the white lines 41 (indicated by dot lines in FIGS. 5A to 5D) are formed with the white ink so as to intersect the color line 40. That is, white-colored ink test pattern with a line width corresponding to one nozzle is formed in the main scanning direction X. Then, the color line 40 is covered with the white-colored ink ejected on the color line 40, and thus the color line 40 looks like a discontinuous line by the colored ink.

Accordingly, since the color line 40 formed with the easily visible colored ink looks like s discontinuous line by covering the color line 40 with the white lines 41 of the white-colored ink, an ejection failure of the white-colored ink nozzle 22b can be easily perceived. Moreover, since the ink is ejected so as to form the color line 40 and the white lines 41 on the line, it is possible to reduce ink consumption.

Subsequently, the print head 3 is moved in the main scanning direction X from this color line 40 to a color line (a third color line from the left side in FIGS. 5A to 5D) which is near this color line 40 by one color line, and then ejects the white-colored ink on the color line 40 from a second white-colored ink nozzle 22b (#2) so as to draw the white line 41 corresponding to the interval P between the color lines 40 on the color line 40. This operation is repeated on every other color line 40 by ejecting the white-colored ink sequentially from 1st to 90th white-colored ink nozzles 22b belonging to the nozzle row 36W. The print head 3 returns to the initial side, when the ejection of the white-colored ink toward the final color line 40 ends. Subsequently, the print medium 2 is transported by one nozzle in the sub-scanning direction Y, when the print head 3 returns to the initial side. Then, while the print head 3 is moved again in the main scanning direction X, the white-colored ink is repeatedly ejected on each color line 40 sequentially from the 1st to 90th white-colored ink nozzles 22b belonging to the nozzle row 36W.

In this embodiment, by reciprocating (passing) the print head 3 six times to eject the white-colored ink from the same white-colored ink nozzles 22b, the white lines 41 corresponding to the six nozzles are formed side by side in the sub-scanning direction Y. In this way, a white color group 45 constituted by the white lines 41 formed by ejecting the white-colored ink from the same white-colored ink nozzles 22b disconnects each of the color lines 40 and thus the line width of the white-colored ink test pattern can be made thick seemingly (see FIG. 5B). Accordingly, since the area of the color line 40 covered with the white line 45 becomes broader, the ejection failure of the white-colored ink nozzles 22b can be easily perceived.

Subsequently, the white-colored ink is repeatedly ejected onto every other color line 40, which includes a color line 40 (a second color line from the left side in FIGS. 5A to 5D) located near the color line 40 on the most initial side of the white-colored ink and the color lines 40 separated by one color line, from 91st to 180th white-colored ink nozzles 22b belonging to the nozzle row 36W. Then, as shown in FIG. 5B, the white-colored ink test patterns with the line width are formed at a predetermined interval by the 91st to 180th white-colored ink nozzles 22b.

Subsequently, after the front end of the color lines 40 on the most initial side is set to the print start position and the plurality of colored ink test patterns (see FIG. 5C) are formed so as to form the color lines 40 from the colored ink nozzles 22a, the white-colored ink test patterns of the white lines 41 are formed sequentially by 181st to 270th white-colored ink nozzles 22b and 271st to 360th white-colored ink nozzles 22b belonging to the nozzle row 36W, just as the white-colored ink test patterns of the white lines 41 are formed by the 1st to 180th white-colored ink nozzles 22b belonging to the nozzle row 36W.

Next, the case where the ejection failure of the white-colored ink occurs will be described. First, in the test patterns drawn when a flying curve of the white-colored ink occurs, the position of a white line group 45 (indicated by Y1 in FIG. 5B) constituted by the white lines 41 formed by 91st and 93rd white-colored ink nozzles 22b is deviated (indicated by dY in FIG. 5B) from the position of a white line group 45 (indicated by Y2 in FIG. 5B) constituted by the white lines 41 formed by a 92nd white-colored ink nozzle 22b. Therefore, it is possible to determine that the flying curve of the white line formed by the 92nd white-colored ink nozzle 22b has occurred. As for the test pattern formed when the white-colored ink is not ejected, the color line 40 in the area of the white line group 45 constituted by the white lines 41 formed by a 272nd white-colored ink nozzle 22b is not discontinuous, as indicated by a circle of a one-dot line in FIG. 5D. Therefore, it is possible to determine that the white-colored ink is not ejected by the 272nd white-colored ink nozzle 22b. In this case, in order to remove the thickened ink or remove mixed bubbles, the capping mechanism 7 performs a recovery process such as a flushing process or a cleaning process on the white-colored ink nozzle 22b determined that the white-colored ink is not normally ejected.

The invention is not limited to the above-described embodiment, but may be modified in various forms on the basis of the description of claims.

In the above-described embodiment, the operation of forming the color line 40 and the operation of forming the white line 41 are performed independently, but the invention is not thereto. For example, the operation of ejecting the colored ink and the operation of ejecting the white-colored ink from the print head 3 may be performed alternately, while the print head 3 is relatively moved with respect to the print medium 2. That is, the white-colored ink may be ejected on the color line 40 formed by ejecting the colored ink. As for an order of ejecting the white-colored ink from the white-colored ink nozzles 22b belonging to the nozzle row 36W, the white-colored ink may be ejected sequentially from any white-colored ink nozzle 22b.

The plurality of color lines 40 has been formed, but the invention is not limited thereto. For example, the white-colored ink may be ejected onto one color line 40 so that the white lines 41 formed in different length directions intersect the color line 40. Only one white line 41 may be formed. The color line 40 and the white line 41 may be formed by ejecting the colored ink and the white-colored ink so that the direction of the color line 40 and the direction of the white color 41 are changed with each other. Alternatively, the color line 40 and the white color 41 may not be formed so as to be perpendicular to each other, but may be formed so as to intersect with each other at an arbitrary angle such as 30 degrees. The white-colored ink is not limited to pure white-colored ink, but may be ink with the same hue as that of the ground color of the print medium 2. For example, a straw-colored ink may be used.

Any liquid having at least a predetermined color may be used. A functional liquid used in a display manufacturing apparatus which manufactures a color filter such as a liquid crystal display, an organic EL (Electro Luminescence) display, an electrode manufacturing apparatus which forms an electrode such as an FED (Field Emission Display), a chip manufacturing apparatus which manufacture a bio chip (biochemical element), etc. may be used as ink.

What is claimed is:

1. A printing apparatus comprising:
a white-colored ink nozzle which ejects white-colored ink;
a colored ink nozzle which ejects colored ink different from the white-colored ink;
a scanning mechanism which moves the nozzles and a print medium, onto which the ejected ink is landed, relative to each other; and
a controller which controls the ink ejection of the nozzles and the scanning mechanism,
wherein the controller forms a color line by ejecting the colored ink onto the print medium, while relatively moving the nozzle with respect to the print medium in a first direction, and then the controller ejects the white-colored ink on the color line so as to draw white lines intersecting the color line by moving the nozzle and the print medium relative to each other in a second direction intersecting the first direction.

2. The printing apparatus according to claim 1,
wherein a plurality of the white-colored ink nozzles are provided, and
wherein the controller ejects the white-colored ink so that the white lines formed by different white-colored ink nozzles among the plurality of white-colored ink nozzles are formed on the color line at a predetermined interval.

3. The printing apparatus according to claim 2, wherein the controller ejects the white-colored ink so that a white line group with a thick width is formed by ejecting the white-colored ink from specific white-colored ink nozzles and drawing the white lines several times.

4. The printing apparatus according to claim 3, wherein the controller forms a plurality of the color lines, and then ejects the white-colored ink so that the white lines formed by being ejected from the different white-colored ink nozzles are arranged in a straight line shape on each of the color lines.

5. The printing apparatus according to claim 1, further comprising a recovery processing unit which performs a recovery process of the white-colored ink nozzles when it is determined that an ejection failure occurs in the white-colored ink nozzle on the basis of the white line.
